(19) United States
(12) Patent Application Publication
(10) Pub. No.: US 2005/0068204 A1
(43) Pub. Date: Mar. 31, 2005

(54) Reliable decoder and decoding method

(75) Inventors: Jong-gu Jeon, Suwon-Si (KR); Ju-hee Park, Suwon-Si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/922,170

(22) Filed: Aug. 20, 2004

(30) Foreign Application Priority Data
Aug. 20, 2003 (KR) 2003-57504

(51) Int. Cl. H04J 3/24

(52) U.S. Cl. 341/50

(57) ABSTRACT

A reliable decoder and decoding method in a digital multimedia broadcast reception system. The reliable decoding method includes: performing an interrupt service routine to store a stream index; reading the stored stream index if an interrupt call signal is received and by depacketizing a packet having the read stream index, extracting decoding information; and by referring to extracted decoding information, reading a payload included in the packet and decoding the read payload. Accordingly, since preparation of decoding is processed by using an interrupt method, a plurality of elements do not need to be checked continuously unlike in a polling method, such that the performance of an MPEG-4 system is enhanced.

### CROSS-REFERENCE TO RELATED APPLICATIONS

This application claims the priority of Korean Patent Application No. 2003-57504, filed on Aug. 20, 2004 in the Korean Intellectual Property Office, the disclosure of which is incorporated herein in its entirety by reference.

### BACKGROUND OF THE INVENTION

1. Field of the Invention

The present invention relates to digital multimedia broadcast reception, and more particularly, to a moving picture experts group 4 (MPEG-4) system.

2. Description of the Related Art

In a conventional MPEG-4 system, a polling method is used for pre-decoding. However, since a plurality of elements, or device components, continuously check other elements in the polling method, there is a limit on improvements that may be achieved in the performance of an MPEG-4 system using the polling method. In addition, if inbound traffic is congested because the bit rate of a received transport stream is not constant, loss of packets occurs and ultimately, reliable decoding cannot be achieved.

### SUMMARY OF THE INVENTION

According to an aspect of the present invention an apparatus and method by which preparation of decoding is processed by using an interrupt method such that a plurality of elements do not need to be continuously checked unlike in a polling method is provided.

According to an aspect of the present invention, there is provided a first reliable decoding method including: if an interrupt call signal is received, performing an interrupt service routine to store a stream index; reading the stored stream index and by depacketizing a packet having the read stream index, extracting decoding information; and by referring to extracted decoding information, reading a payload included in the packet and decoding the read payload.

According to another aspect of the present invention, there is provided a first reliable decoding apparatus including: an interrupt service routine performing unit which if an interrupt call signal is received, performs an interrupt service routine to store a stream index; a packet parsing unit which reads the stored stream index and by depacketizing a packet having the read stream index, extracts decoding information; and a decoding unit which by referring to extracted decoding information, reads a payload included in the packet and decodes the read payload.

According to another aspect of the present invention, there is provided a second reliable decoding method including: if an interrupt call signal from a central processing unit (CPU) is received, performing an interrupt service routine to store a stream index of packets stored in each stream in a packet buffer, in a stream index queue; reading the stored stream index from the stream index queue, reading packets having the read stream index, from the packet buffer, extracting decoding information by depacketizing the read packets, and storing the extracted decoding information by the stream in a decoding information buffer; and by referring to the decoding information stored in each stream in the decoding information buffer, reading payloads included in the packets stored in each stream in the packet buffer, and decoding the read payloads.

According to another aspect of the present invention, there is provided a second reliable decoding apparatus including: an interrupt service routine performing unit which if an interrupt call signal from a CPU is received, performs an interrupt service routine to store a stream index of packets stored in each stream in a packet buffer, in a stream index queue; a packet parsing unit which reads the stored stream index from the stream index queue, reads packets having the read stream index from the packet buffer, extracts decoding information by depacketizing the read packets, and stores the extracted decoding information by the stream in a decoding information buffer; and a decoding unit which by referring to the decoding information stored by the stream in the decoding information buffer, reads payloads included in the packets stored by the stream in the packet buffer, and decodes the read payloads.

According to a further aspect of the present invention, there is provided a computer readable recording medium having embodied thereon a computer program for executing the first reliable decoding method.

According to an additional aspect of the present invention, there is provided a computer readable recording medium having embodied thereon a computer program for executing the second reliable decoding method.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of the structure of a digital multimedia broadcast receiver to which embodiments of the present invention can be applied;

FIG. 2 is a diagram of the structure of a reliable decoding apparatus according to an embodiment of the present invention;

FIG. 3 is a diagram showing the relations among a transport stream packet, a packetized elementary stream (PES) packet, and a 14496 section complying with the MPEG-4 standard;

FIG. 4 is a diagram showing a storage format of the packet buffer shown in FIG. 2;

FIG. 5 is a detailed diagram of the structure of the transport stream demultiplexer shown in FIG. 2;

FIG. 6 is a detailed diagram of the structure of the interrupt service routine performing unit shown in FIG. 2;

FIG. 7 is a detailed diagram of the structure of the packet parsing unit shown in FIG. 2; and

FIG. 8 is a flowchart of a reliable decoding method according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

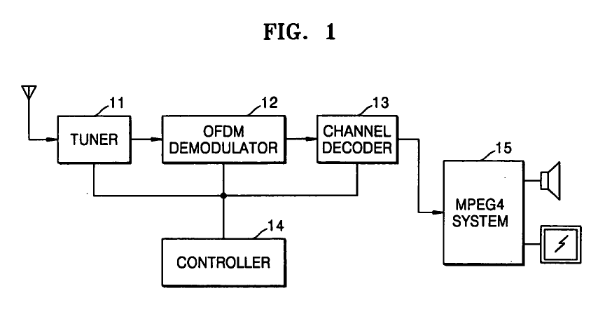

A digital multimedia broadcasting system is a broadcasting system providing multimedia services such as various video, audio, and data, to a mobile user, for example, a user in a car or a user on foot. Referring to FIG. 1, a digital multimedia broadcast receiver, which may be a part of the digital multimedia broadcasting system or a separate device, includes a tuner 11, an orthogonal frequency division multiplexing (OFDM) demodulator 12, a channel decoder 3, a controller 14, and a moving picture experts group-4 (MPEG-4) system 15.

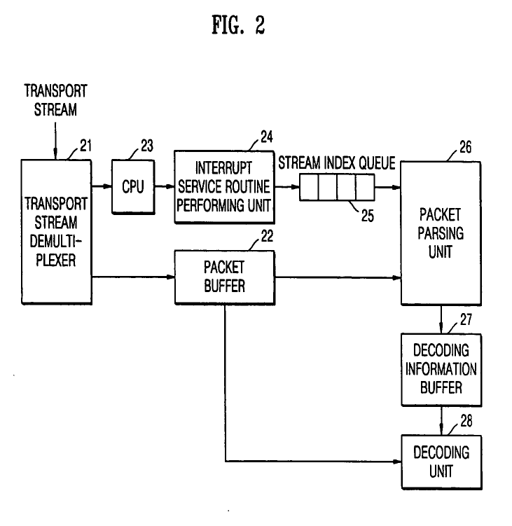

FIG. 2 is a diagram of the structure of a reliable decoding apparatus according to an embodiment of the present invention. The reliable decoding apparatus includes a transport stream (TS) demultiplexer 21, a packet buffer 22, a central processing unit (CPU) 23, an interrupt service routine (ISR) performing unit 24, a stream index queue 25, a packet parsing unit 26, a decoding information buffer 27, and a decoding unit 28.

The TS demultiplexer 21 extracts predetermined packets by depacketizing transport stream packets included in a transport stream transmitted by the channel decoder 13 of the digital multimedia broadcast receiver shown in FIG. 1. The TS demultiplexer 21 then stores the extracted packets corresponding to each stream in the packet buffer 22, and requests an interrupt for the packets stored in units of streams, to the CPU 23.

If an interrupt service routine call signal from the CPU 23 receiving the interrupt requested by the TS demultiplexer 21 is received, the ISR performing unit 27 performs an interrupt service routine to store a stream index of the packet stored in the packet buffer 22 in the stream index queue 25.

The packet parsing unit 26 reads a stream index from the stream index queue 25, reads the packet having the stream index from the packet buffer 22, extracts decoding information by depacketizing the read packet, and stores the extracted decoding information in each stream in the decoding information buffer 27. By referring to the decoding information stored in each stream in the decoding information buffer 27, the decoding unit 28 reads payloads included in the packets which are stored in corresponding units of streams in the packet buffer 22, and decodes the read payloads.

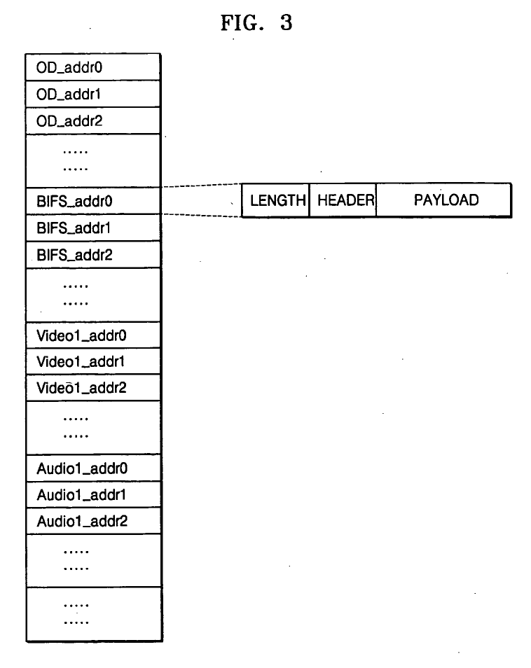

FIG. 3 is a diagram showing the relationships between a transport stream packet, a packetized elementary stream (PES) packet, and a 14496 section complying with the MPEG-4 standard.

The receiver shown in FIG. 1 receives a digital multimedia broadcast signal from a broadcasting station transmitting the digital multimedia broadcast signal. The received digital multimedia broadcast signal is restored to a transport stream through the tuner 11, the OFDM demodulator 12, and the channel decoder 13. The transport stream is transmitted to the MPEG-4 system, that is, the reliable decoding apparatus 15. This transport stream (TS) is formed of transport stream packets, each having a predetermined length (188 bytes). These transport stream packets are classified into program association table (PAT) packets, program map table (PMT) packets, and packets storing an object descriptor (OD) stream, a binary input format for scene (BIFS) stream, an audio stream, and a video stream. The TS demultiplexer 21 obtains a program ID (PID) of a PMT packet by parsing a PAT packet whose PID, which is a stream index, is 0, and obtains PIDs of packets storing an OD stream, a BIFS stream, a video stream, and an audio stream.

Referring to FIG. 3, each TS stream packet is formed with a header and a payload. A predetermined number of the TS stream packets are depacketized and a packetized elementary stream (PES) packet or a 14496 section is generated by combining the depacketized packets. In the payload of the PES packet, a sync layer (SL) packet including a video payload or an audio payload is stored, and in the payload of the 14496 section, a sync layer (SL) packet including an OD payload or a BIFS payload is stored. An access unit (AU) stream, for example, one frame of a video stream or one frame of an audio stream, is stored in each of the payloads of the sync layer packets. However, since the length of an AU stream is not constant, information on the length of the sync layer packet is also stored in the header of the PES packet or the 14496 section. Generally, when an AU stream is a video stream, the AU stream is long, while when the AU stream is an OD stream or a BIFS stream, the AU stream is short.

A case where the packet is a sync layer packet will now be explained with reference to examples. The TS demultiplexer 21 depacketizes transport stream packets included in a transport stream, and then, by combining payloads of the depacketized transport stream packets, extracts a PES packet or a 14496 section. The TS demultiplexer 21 extracts a sync layer packet from the extracted PES packet or 14496 section, and stores the extracted sync layer packet by the stream in the packet buffer 22. When a sync layer packet is stored in each stream in the packet buffer 22, an interrupt for the sync layer packet stored by the stream is requested to the CPU 23.

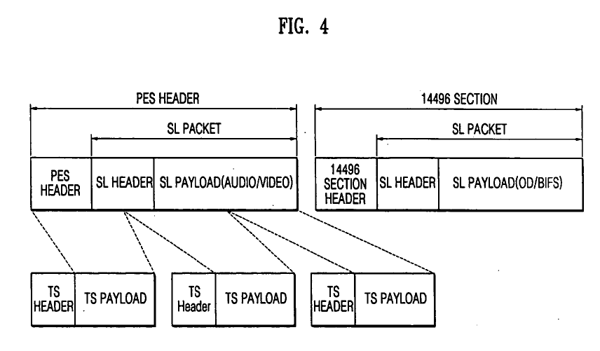

FIG. 4 is a diagram showing a storage format of the packet buffer 22 shown in FIG. 2. Referring to FIG. 4, the length of a sync layer packet and a sync layer packet corresponding to this length are stored at each address of the packet buffer 22. In the packet buffer 22, packets are stored in units of streams having identical PIDs such as an OD area, a BIFS area, a video 1 area, and an audio 1 area. Since each of these PIDs is an index indicating a stream, a PID will be referred to hereinafter as a stream index.

N sync layer packets can be stored in one stream area. The reason packets in each stream are stored as described above is that if streams are classified before the packet buffer 22, the streams do not need to be classified again in the decoding unit 28 in which the workload is heavy. Also, while decoding is performed in the decoding unit 28, classifying the streams is performed at the same time such that the processing speed of the MPEG-4 system as a whole can be enhanced.

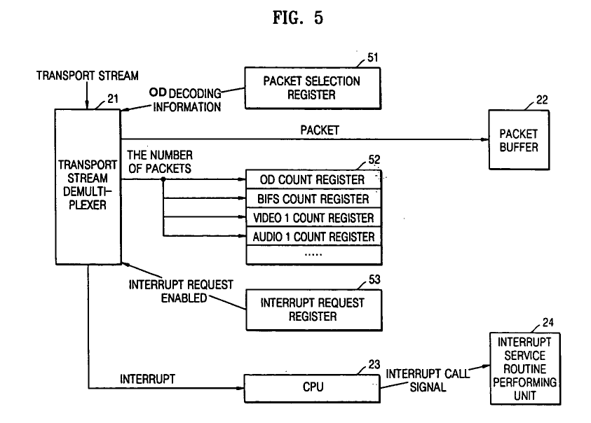

FIG. 5 is a detailed diagram of the structure of the TS demultiplexer 21 shown in FIG. 2. Referring to FIG. 5, the TS demultiplexer 21 extracts TS packets from the transport stream by depacketizing the transport stream packets having a stream index stored in the packet selection register 51. The stream indexes stored in the packet selection register 51 are determined according to OD decoding information in the decoding information extracted by the packet parsing unit 26. OD decoding information is the PID of a stream that should be decoded later in order to reproduce a digital multimedia broadcast set by a user. As described above, the TS demultiplexer 21 stores the extracted packets in each stream in the packet buffer 22, and in relation to the packets stored in each stream, stores a number of packets stored for each individual stream in individual stream count registers 52. For example, if 2 sync layer packets storing an OD stream, and one sync layer packet storing a video stream are stored by the stream in the packet buffer 22 between interrupts, 2 is added to the OD count register and 1 is added to the video count register. At this time, the TS demultiplexer 21 requests an interrupt, and stores packets that are extracted between the requested interrupt and the interrupt requested immediately before the currently requested interrupt, by the stream only when a value stored in the interrupt request register 53 indicates that the interrupt request is enabled. Here, the value stored in the interrupt request register 53 indicating that the interrupt request is enabled is a value that is stored when an interrupt service routine is completed in the ISR performing unit 24.

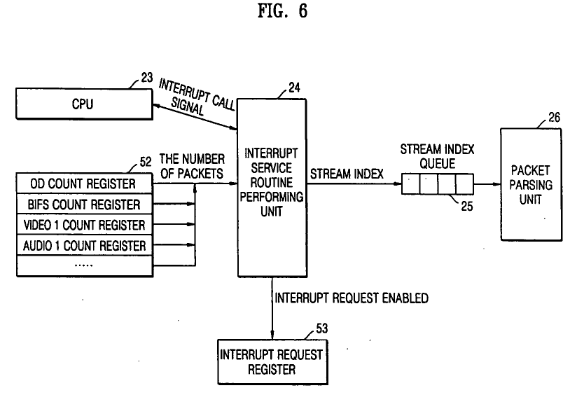

FIG. 6 is a detailed diagram of the structure of the ISR performing unit 24 shown in FIG. 2. Referring to FIG. 6, if an interrupt call signal from the CPU 23 is received, the ISR performing unit 24 performs an interrupt service routine. Here, the interrupt service routine is a function that is performed with priority, after stopping other jobs or functions performed by the MPEG-4 system, if an interrupt is requested. Since information required for performing an interrupt service routine is exchanged by using registers as described above, the interrupt can be processed in a very short time. Accordingly, when the entire performance of the MPEG-4 system is considered, this interrupt hardly affects decoding jobs. When the interrupt service routine begins, first, the number of packets in each individual stream is read from the individual stream count registers 52. Stream indexes corresponding to the number of packets in each individual stream are stored in the steam index queue 25. For example, if 2 is stored in the OD count register and 1 is stored in the video 1 count register, the PID of the OD stream is stored twice (i.e., once for each OD sync layer packet) and the PID of the video stream is stored once in the stream index queue 25.

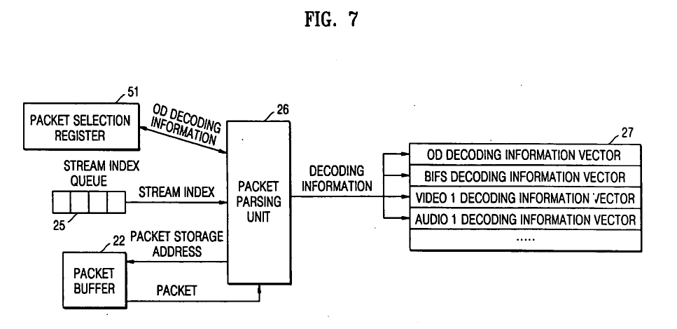

FIG. 7 is a detailed diagram of the structure of the packet parsing unit 26 shown in FIG. 2. Referring to FIG. 7, the packet parsing unit 26 reads the stream index stored in the stream index queue 25. Since sync layer packets are stored by the stream in the packet buffer 22, the storage area for each stream is always identical. Accordingly, the storage location of the packet of the stream index can be identified with only a stream index. However, a start address of each individual stream area should be fixedly stored such that, by reading the stream indexes stored in the stream index queue 25 sequentially from the start address, the packet parsing unit 6 can read the correct packets. The packet parsing unit 26 depacketizes the read packets to extract decoding information, and stores the extracted decoding information by the stream in the decoding information buffer 27. By referring to the decoding information stored by the packet parsing unit 26 for each stream in the decoding information buffer 27, the decoding unit 28 reads payloads included in the packets stored by the stream in the packet buffer 22, and decodes the read payloads in units of streams simultaneously.

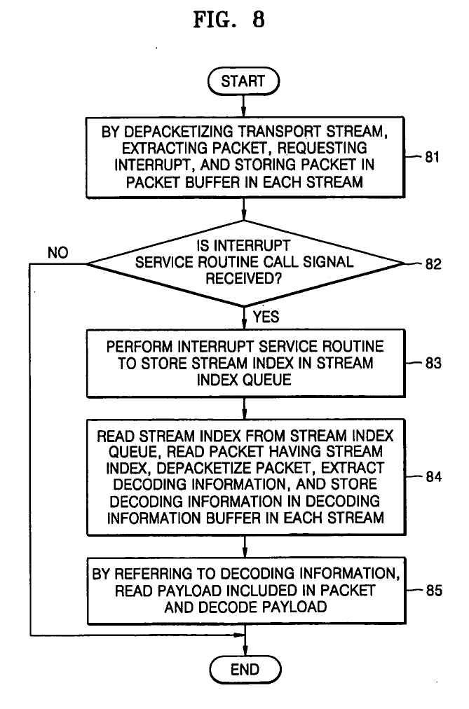

FIG. 8 is a flowchart of a reliable decoding method according to an embodiment of the present invention. Referring to FIG. 8, the operations of the reliable decoding method will now be explained.

By depacketizing transport stream packets included in a transport stream, packets are extracted, and stored by the stream in a packet buffer 22, and an interrupt for the packets stored in each stream is requested to a CPU 23 in operation 81. At this time, the extracted packets are stored in each stream in the packet buffer 22 and in relation to the packets stored in each stream, the numbers of packets in respective streams are stored in individual stream count registers 52 in operation 81. If an interrupt service routine call signal is received from the CPU 23, which receives the requested interrupt, in operation 82, then an interrupt service routine to store the stream indexes of packets recorded in the packet buffer 22 in a stream index queue 25 is performed in operation 83. At this time, the same number of stream indexes as the number of packets in each individual stream which are stored in the individual stream count registers 52 are stored in the stream index queue 25, and an interrupt service routine to store in an interrupt request register 53 a value indicating that an interrupt request is enabled is performed. Operation 81 is performed only when the value stored in the interrupt request register 53 indicates that an interrupt request is enabled, and packets that are extracted between the requested interrupt and the interrupt requested immediately before the currently requested interrupt are stored in each stream.

Next, a stream index is read from the stream index queue 25, a packet having the read stream index is read from the packet buffer 22, decoding information is extracted by depacketizing the read packet, and the extracted decoding information is stored in each stream in a decoding information buffer 27 in operation 84. Then, by referring to the decoding information stored in each stream in the decoding information buffer 27, the payloads included in the packets stored in each stream in the packet buffer 22 are read and decoded in operation 85. At this time, in the operation 85, a stream index determined according to an OD descriptor decoding information in the extracted decoding information is stored in a packet selection register, and in operation 81, packets are extracted by depacketizing transport stream packets having stream indices stored in the packet selection register 51, among transport stream packets included in the transport stream. The packets are sync layer packets in an aspect of the present invention.

The embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

According to embodiments of the present invention, since preparation of decoding is processed by using an interrupt method, a plurality of components in the digital multimedia broadcast receiver do not need to be checked continuously unlike in a polling method, such that the performance of an MPEG-4 system is enhanced.

Also, according to embodiments of the present invention, by introducing a stream index queue, a process of performing an interrupt service routine and a process of parsing packets are performed independently in parallel such that the performance of the MPEG-4 system is improved.

Furthermore, according to embodiments of the present invention, by introducing the stream index queue, all received packets are decoded without loss, and ultimately reliable decoding can be implemented.

Although a few embodiments of the present invention have been shown and described, it would be appreciated by those skilled in the art that changes may be made in these embodiments without departing from the principles and spirit of the invention, the scope of which is defined in the claims and their equivalents.

1. A reliable decoding method, comprising:
performing an interrupt service routine to store a stream index corresponding to streams if an interrupt call signal is received;
reading the stored stream index and extracting decoding information from the corresponding stream by depacketizing a packet having the read stream index; and
reading a payload included in the packet and decoding the read payload by referring to the extracted decoding information.

2. The method of claim 1, wherein the packet is a sync layer packet.

3. The method of claim 1, further comprising storing the extracted decoding information in each stream when the interrupt call signal is received, and the payload included in the packet stored in each stream is read by referring to the decoding information stored in each stream.

4. The method of claim 1, further comprising:
extracting the packets by depacketizing transport stream packets included in a transport stream, storing the extracted packets by the stream, and requesting the interrupt for the packets stored in each stream.

5. The method of claim 4, further comprising
accumulating a number of packets stored in each stream,
wherein the performing the interrupt service routine comprises storing a value indicating that an interrupt request is enabled and storing a same number of stream indexes as the number of packets.

6. The method of claim 5, further comprising:
requesting the interrupt call signal only when the value indicating that the interrupt request is enabled is stored; and
extracting packets between the requested interrupt and a previous interrupt requested immediately before the requested interrupt and storing the extracted packets in each stream.

7. The method of claim 4, wherein the reading the stored stream index and extracting the decoding information by depacketizing the packet having the read stream index, comprises storing the stream index determined according to object descriptor decoding information in the extracted decoding information, and
the extracting the packets by depacketizing the transport stream packets included in the transport stream, storing the extracted packets by the stream, and requesting the interrupt for the packets stored in each stream, comprises extracting the packets by depacketizing the transport stream packets having the corresponding stream index determined according to the object descriptor decoding information.

8. A reliable decoding apparatus, comprising:
an interrupt service routine performing unit which if an interrupt call signal is received, performs an interrupt service routine to store a stream index;
a packet parsing unit which reads the stored stream index and by depacketizing a packet having the corresponding read stream index, extracts decoding information; and
a decoding unit which by referring to the extracted decoding information, reads a payload included in the packet and decodes the read payload.

9. The apparatus of claim 8, wherein the interrupt service routine performing unit performs the interrupt service routine to store the stream index of the corresponding packet stored in each stream, and the decoding unit reads the payload included in the packet stored in each stream, by referring to the decoding information stored in each stream.

10. The apparatus of claim 8, further comprising:
a transport stream demultiplexer which by depacketizing transport stream packets included in a transport stream, extracts the packets, stores the extracted packets according to the corresponding stream, and requests an interrupt for the packets stored in each stream.

11. A reliable decoding method, comprising:
performing an interrupt service routine to store a stream index, of packets stored in each stream in a packet buffer, in a stream index queue if an interrupt call signal from a central processing unit (CPU) is received;
reading the stored stream index from the stream index queue, reading packets having the read stream index, from the packet buffer, extracting decoding information by depacketizing the read packets, and storing the extracted decoding information by the stream in a decoding information buffer; and
reading payloads included in the packets stored in each stream in the packet buffer, and decoding the read payloads by referring to the decoding information stored in each stream in the decoding information buffer.

12. The method of claim 11, wherein the packet is a sync layer packet.

13. The method of claim 11, further comprising:
extracting the packets by depacketizing transport stream packets included in a transport stream, storing the extracted packets by the stream in the packet buffer, and requesting an interrupt for the packets stored in each stream, to the CPU.

14. The method of claim 13, further comprising:
accumulating a number of packets stored in each stream in individual stream count registers,
wherein the performing the interrupt service routine comprises storing a value indicating that an interrupt request is enabled and storing a same number of stream indexes as the number of packets in the stream index queue.

15. The method of claim 14, wherein the extracting the packets by depacketizing transport stream packets included in a transport stream, storing the extracted packets by the stream in the packet buffer, and requesting an interrupt for the packets stored in each stream, to the CPU, comprises requesting the interrupt call signal only when the value stored in the interrupt request register indicates that an interrupt request is enabled, and the packets extracted between the requested interrupt call signal and a previous interrupt requested immediately before the requested interrupt call signal are stored in each stream.

16. The method of claim 13, wherein the reading the payloads included in the packets stored in each stream in the packet buffer and decoding the read payloads, comprises storing the stream index determined according to object descriptor decoding information in the extracted decoding information in a packet selection register, and
the extracting the packets by depacketizing the transport stream packets included in the transport stream, storing the extracted packets by the stream in the packet buffer, and requesting an interrupt for the packets stored in each stream, to the CPU, comprises extracting the packets by depacketizing the transport stream packets having the corresponding stream index stored in the packet selection register, among the transport stream packets included in the transport stream.

17. A reliable decoding apparatus, comprising:
an interrupt service routine performing unit which if an interrupt call signal from a processor is received, performs an interrupt service routine to store a corresponding stream index of packets stored in each stream in a packet buffer, in a stream index queue;
a packet parsing unit which reads the stored stream index from the stream index queue, reads the packets having the read stream index from the packet buffer, extracts decoding information by depacketizing the read packets, and stores the extracted decoding information according to the stream in a decoding information buffer; and
a decoding unit which by referring to the decoding information stored in each stream in the decoding information buffer, reads payloads included in the packets stored in each stream in the packet buffer, and decodes the read payloads.

18. A computer readable recording medium having embodied thereon a computer program for a reliable decoding method, wherein the method comprises:
performing an interrupt service routine to store a stream index if an interrupt call signal is received;
reading the stored stream index and extracting decoding information by depacketizing a packet having the read stream index; and
reading a payload included in the packet and decoding the read payload by referring to extracted decoding information.

19. A computer readable recording medium having embodied thereon a computer program for a reliable decoding method, wherein the method comprises:
performing an interrupt service routine to store a stream index of packets stored in each stream in a packet buffer, in a stream index queue if an interrupt call signal from a processor is received;
reading the stored stream index from the stream index queue, reading packets having the read stream index from the packet buffer, extracting decoding information by depacketizing the read packets, and storing the extracted decoding information by the stream in a decoding information buffer; and
reading payloads included in the packets stored in each stream in the packet buffer, and decoding the read payloads by referring to the decoding information stored in each stream in the decoding information buffer.

20. An MPEG-4 decoding apparatus, comprising:
input means for inputting a transport stream comprising a plurality of packets of a plurality of object stream types;
separation means for separating each packet according to the type of the object streams from the input transport stream;
storing means for storing the separated packets according to the type of the object streams when an interrupt request is received by the MPEG-4 decoding apparatus;
parsing means for extracting decoding information from the stored packets according to the type of the object streams; and
decoding means for decoding payloads in the stored packets according to the extracted decoding information from the parsing means.

21. The apparatus according to claim 20, wherein the transport stream includes at least one of an object descriptor object stream, a binary input format for scene object stream, an audio object stream, or a video object stream.

22. The apparatus according to claim 20, wherein the packets are sync layer packets.

23. The apparatus according to claim 20, wherein the packets are one of a packetized elementary stream packet and a 14496 section packet complying with the MPEG-4 standard.

24. The apparatus according to claim 20, wherein the storing means and the parsing means are performed independently.

25. An MPEG-4 decoding method, comprising:
inputting a transport stream comprising a plurality of packets of a plurality of object stream types;
separating each packet according to the type of the object streams from the input transport stream;
storing the separated packets according to the type of the object streams when an interrupt request is generated by the MPEG-4 decoding apparatus;
extracting decoding information from the stored packets according to the type of the object streams; and
decoding payloads in the stored packets according to the extracted decoding information.

26. The method of claim 25, wherein the storing the packets comprises storing the packets in groups according to the type of the object streams by referring to a stream index associated with each packet.

27. The method of claim 25, further comprising:
counting a number of packets stored corresponding to each type of the object streams when the interrupt request is generated.

28. The method of claim 27, wherein the extracting the decoding information from the stored packets according to the type of the object streams is based on the number of packets counted.

29. The method of claim 25, wherein the storing the separated packets comprises storing the packets separated between the interrupt request and a previous interrupt request.

30. The method of claim 25, wherein performance of the MPEG-4 decoding apparatus is enhanced because the decoding is based on the interrupt request generation.

31. A decoding apparatus, comprising:
a receiver receiving a transport stream comprising a plurality of packets of a plurality of object stream types;
a demultiplexer separating each packet according to the type of the object streams from the input transport stream;
an interrupt processor storing the separated packets according to the type of the object streams when an interrupt request is received;
a parser parsing decoding information from the stored packets according to the type of the object streams; and
a decoder decoding payloads in the stored packets according to the extracted decoding information from the parser.

32. The apparatus according to claim 31, wherein the transport stream includes at least one of an object descriptor object stream, a binary input format for scene object stream, an audio object stream, or a video object stream.

33. The apparatus according to claim 31, wherein the packets are sync layer packets.

34. The apparatus according to claim 31, wherein the packets are one of a packetized elementary stream packet and a 14496 section packet complying with an MPEG-4 standard.

35. The apparatus according to claim 31, wherein the demultiplexer separates the packets according to the type of the object stream in parallel with the decoding of the payloads.

36. The apparatus according to claim 31, wherein the transport stream is formatted according to an MPEG-4 standard.

37. The apparatus according to claim 31, wherein the demultiplexer separates the packets according to the type of the object stream independently of the decoding of the payloads.
